(19) United States
(12) Patent Application Publication
(10) Pub. No.: US 2005/0200574 A1
(43) Pub. Date: Sep. 15, 2005

(54) Self light emitting display module, electronic equipment into which the same module is loaded, and inspection method of a defect state in the same module

(75) Inventors: Takashi Goto, Yonezawa-shi (JP); Hiroyuki Sato, Yonezawa-shi (JP); Kazuhiro Satoh, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/076,858

(22) Filed: Mar. 11, 2005

(30) Foreign Application Priority Data
Mar. 12, 2004 (JP) 2004-70264

(51) Int. Cl. G09G 3/30

(52) U.S. Cl. 345/76

(57) ABSTRACT

Provided is a self light emitting display module by which defect can be reported to a user immediately in a case where defect occurs for example in a pixel of a light emitting display panel. Output terminal potentials of constant current sources I1-In which supply constant currents to respective EL elements E11-Enm arranged in a light emitting display panel 1 are drawn via inspection lines TL1-TLn and are selected by a select switch SW1. A selected electrical potential is supplied to first and second comparators CP1, CP2 whose comparison reference potentials differ, and their comparison results are latched by latch circuits LC1, LC2 respectively to be stored in a data register 6 provided as a memory means. A determination is made as to whether or not defect has occurred in a portion of a part including the respective EL elements and respective drivers 2,3 through data stored in the data register 6.

### BACKGROUND OF THE INVENTION

1. Field of the Invention

The present invention relates to a self light emitting display module provided with a light emitting display panel in which for example organic EL (electroluminescent) elements are employed for pixels as self light emitting elements and drive means to drive and light this panel, and particularly to a self light emitting display module having a function that can inspect a defect state in the light emitting display panel, the lighting drive means, a connecting portion between the light emitting display panel and the lighting drive means, or the like and to an inspection method of a defect state in the same module.

2. Description of the Related Art

A display has been installed in many of electronic equipment or the like which have been provided presently, and this display has been necessary and indispensable as a man-machine interface of equipment supporting information-oriented society. In a case where the above-mentioned display is employed in a field in which there is a possibility that trouble in display such as for example of a meter of medical equipment or airplanes and the like may influence a human life, a stricter reliability in a display is required than in a display adopted in consumer equipment such as a cellular telephone, car audio and the like.

For example, regarding injection equipment for a medicine or the like, in the case where a bright leak phenomenon occurs in the scan direction on a portion displaying figures showing an injection amount, a problem that whether a displayed figure is “0” or “8” cannot be determined may occur. A problem which may occur is that pixels of a part on which a decimal point is displayed are not lit so that the figures are read while that a place for figures is erroneously displayed is not being noticed, or the like. It is extremely dangerous for a user to keep using the above-described equipment while perceiving display in a troubled state being normal, and it is needless to say that such a state may cause a serious problem.

Thus, in the display employed in the above-mentioned equipment, in a state of semi-finished goods before the product is shipped, a defect state regarding each pixel arranged in a display panel has been inspected to determine whether or not the degree of defect meets the standard of the product into which this display is loaded (for example, see Japanese Patent Publication No. 3437152).

Meanwhile, the invention disclosed in Japanese Patent Publication No. 3437152 is to execute evaluation of each pixel of a display panel in a state of semi-finished goods before the product is shipped, and an object thereof is to provide an evaluation device through which results having high reliability can be obtained utilizing a drive circuit for inspecting an organic EL display.

In a case where the evaluation device disclosed in Japanese Patent Publication No. 3437152 is utilized, although an effect that an initial defect of a product can be detected to deal with the defect before the display panel having the defect is delivered to a user can be produced, this type of display has a problem that a defect may newly occur in pixels arranged in a display panel while the display unit is in operation after shipment of the product. Further, there is a problem that not only may the defect newly occur in pixels arranged in a display panel but also a defect may occur newly even in drive means including a data driver or a scan driver which drive and light each pixel arranged in the display panel or a connecting portion between the display panel and the drive means or the like.

Thus, various countermeasures for keeping the extent that such a defect occurs at a minimum to ensure reliability have been adopted. However, to overcome the problem of defect of pixels occurring during the operation of the display or the like or the problem that defect occurs in the above-mentioned drive means or the like, extremely numerous technical problems exist, and we have to say that it is difficult to provide a display module in which the above-mentioned defect does not occur after the shipment of the product.

### SUMMARY OF THE INVENTION

The present invention has been developed as attention to the above-described realistic problems has been paid, and it is an object of the present invention to provide a self light emitting display module which is provided with a detection means which can inspect whether or not there is a defect occurring in the display panel, the drive means, or the like and in which when a defect of pixels or the like occurs, this state can be reported to a user so that erroneous display information can be prevented from being conveyed to the user and a inspection method of a defect state in the same module.

A self light emitting display module according to the present invention made to carry out the above-described object is a self light emitting display module comprising a self light emitting display unit composed of a light emitting display panel in which a large number of pixels including self light emitting elements are arranged at intersection positions between scan lines and data lines in a matrix pattern and drive means for selectively driving and lighting the respective self light emitting elements in the light emitting display panel, a trouble detection means for detecting trouble in the self light emitting display unit, and a memory means for storing detection results which are obtained by the trouble detection means, wherein the trouble detection means is constructed in such a way that an output terminal potential of a constant current source which supplies a constant current to the self light emitting elements is compared with a preset reference potential so as to detect trouble in the self light emitting display unit.

An inspection method of a defect state in a self light emitting display module according to the present invention made to carry out the above-described object is an inspection method of a defect state in a self light emitting display module which comprises a self light emitting display unit composed of a light emitting display panel in which a large number of pixels including self light emitting elements are arranged at intersection positions between scan lines and data lines in a matrix pattern and drive means for selectively driving and lighting the respective self light emitting elements in the light emitting display panel, a trouble detection means for detecting trouble in the self light emitting display unit, and a memory means for storing detection results which are obtained by the trouble detection means, wherein a trouble detection step in which while a voltage comparison means provided in the trouble detection means is utilized, an output terminal potential of a constant current source which supplies a constant current to the self light emitting elements is compared with a preset reference potential so as to detect trouble in the self light emitting display unit and a detection result storing step in which detection results detected in the trouble detection step are stored in the memory means are executed in all combinations between the respective data lines and the respective scan lines which correspond to the respective pixels respectively.

### BRIEF DESCRIPTION OF THE DRAWINGS

FIG. 1 is a circuit structure diagram showing a first embodiment of a self light emitting display module according to the present invention.

FIG. 2 is a block diagram showing an example of a connection structure of a defect location determination means and a defect report means which utilize data stored in the data register shown in FIG. 1.

FIG. 3 is an explanatory view showing a determination method performed in the defect location determination means shown in FIG. 2.

FIG. 4 is a circuit structure diagram showing a second embodiment of a self light emitting display module according to the present invention.

### DESCRIPTION OF THE PREFERRED EMBODIMENTS

A self light emitting display module according to the present invention will be described below with reference to the embodiments shown in the drawings. In the self light emitting display module according to the present invention, provided are a self light emitting display unit composed of a light emitting display panel in which a large number of self light emitting elements are arranged as pixels in a matrix pattern and drive means for selectively driving and lighting the respective light emitting elements in this light emitting display panel, and further provided are a trouble detection means for detecting trouble of a self light emitting display unit and a memory means for storing detection results of the trouble detection means. In the embodiments explained below, shown is an example in which organic EL elements in which an organic material is employed in a light emitting layer are adopted as the self light emitting elements.

The organic EL element can be electrically replaced by a structure composed of a light emitting component having a diode characteristic and a parasitic capacitance component which is connected in parallel to this light emitting component, and it can be said that the organic EL element is a capacitive light emitting element. When a light emission drive voltage is applied to this organic EL element in a forward direction, at first, electrical charges corresponding to the electric capacity of this element flow into the electrode as displacement current and are accumulated. It can be considered that when the light emission drive voltage then exceeds a predetermined voltage (light emission threshold voltage=Vth) peculiar to this element, current begins to flow from one electrode (anode side of the diode component) to an organic layer constituting the light emitting layer so that the element emits light at an intensity proportional to this current.

Meanwhile, regarding the organic EL element, due to reasons that the voltage-intensity characteristic thereof is unstable with respect to temperature changes while the current-intensity characteristic thereof is stable with respect to temperature changes and that degradation of the organic EL element is considerable when the organic EL element receives excess current so that the light emission lifetime is shortened, and the like, a constant current drive is performed generally. As display panels in which such organic EL elements are employed, a passive matrix type display panel in which EL elements are arranged in a matrix pattern and an active matrix type display panel in which respective EL elements arranged in a matrix pattern are driven to be lit respectively by a TFT (Thin Film Transistor) have been proposed.

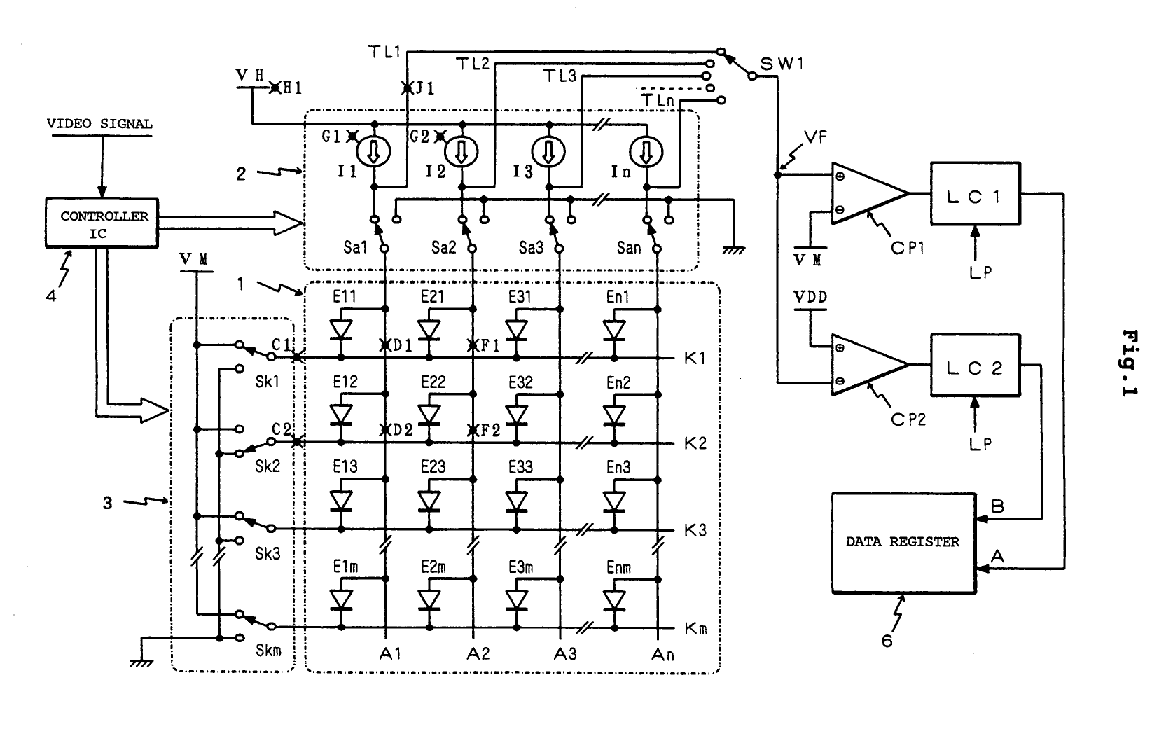

FIG. 1 shows a first embodiment of a self light emitting module according to the present invention, and this shows an example employing the passive matrix type display panel. As drive methods for organic EL elements in this passive matrix type drive method, there are two methods, that is, cathode line scan/anode line drive and anode line scan/cathode line drive, and the structure shown in FIG. 1 shows a form of the former cathode line scan/anode line drive. That is, anode lines A1-An as n data lines are arranged in a vertical direction (column direction), cathode lines K1-Km as m scan lines are arranged in a horizontal direction (row direction), and organic EL elements E11-Enm designated by symbols of diodes are arranged at positions at which the anode lines intersect the cathode lines (in total, n×m portions) to construct a display panel 1.

In the respective EL elements E11-Enm constituting pixels, one ends thereof (anode terminals in equivalent diodes of EL elements) are connected to the anode lines and the other ends thereof (cathode terminals in equivalent diodes of EL elements) are connected to the cathode lines, corresponding to respective intersection positions between the anode lines A1-An extending along the vertical direction and the cathode lines K1-Km extending along the horizontal direction. Further, the respective anode lines A1-An are connected to an anode line drive circuit 2 provided as a data driver constituting lighting drive means, and the respective cathode lines K1-Km are connected to a cathode line scan circuit 3 provided as a scan driver constituting the lighting drive means similarly, so as to be driven respectively.

The anode line drive circuit 2 is provided with constant current sources I1-In which utilize to be operated a drive voltage VH (this is also referred to a first power source) brought from a voltage boost circuit (not shown) for example by a DC-DC converter and drive switches Sa1-San, and the drive switches Sa1-San are connected to the constant current sources I1-Inside so that currents from the constant current sources I1-In are supplied to the respective EL elements E11-Enm arranged corresponding to the cathode lines. In this embodiment, when currents from the constant current sources I1-In are not supplied to the respective EL elements, the drive switches Sa1-San can allow these anode lines to be connected to a ground potential GND (this is also referred to as a third power source).

Meanwhile, the cathode line scan circuit 3 is equipped with scan switches Sk1-Skm, as switching means, corresponding to the respective cathode lines K1-Km, and these scan switches operate to allow either a reverse bias voltage VM (this is also referred to as a second power source) for preventing cross talk light emission or the ground potential GND provided as a reference potential point to be connected to corresponding cathode lines. Thus, the constant current sources I1-In are connected to desired anode lines A1-An while the cathode lines are set at the reference potential point (ground potential) at a predetermined cycle, so that the respective EL elements can be selectively illuminated.

A control bus is connected from a controller IC 4 including a CPU to the anode line drive circuit 2 and the cathode line scan circuit 3. Switching operations of the scan switches Sk1-Skm and the drive switches Sa1-San are performed based on a video signal to be displayed which is supplied to the controller IC 4. Thus, while the cathode scan lines are set to the ground potential at a predetermined cycle based on the video signal, the constant current sources I1-In are connected to desired anode lines. Accordingly, the respective light emitting elements are selectively illuminated so that an image based on the video signal is displayed on the display panel 1.

In the state shown in FIG. 1, the second cathode line K2 is set to the ground potential to be in a scan state, and at this time, the reverse bias voltage VM is applied to the cathode lines K1, K3-Km which are in a non-scan state. Here, where the forward voltage of the EL element in the scan light emission state is VF, settings for respective voltages (a specific example of these voltage settings will be described later herein) are performed so as to meet a relationship of [(forward voltage VF)-(reverse bias voltage VM)]<(light emission threshold voltage Vth). Thus, a voltage of the element's light emission threshold voltage Vth or lower is applied to the respective EL elements connected at the intersections between the driven anode lines and the cathode lines which are not selected for scanning so as to prevent the EL elements from emitting cross talk light.

A self light emitting display unit is composed of the light emitting display panel 1, the anode line drive circuit 2 and the cathode line scan circuit 3 as drive means, and the controller IC 4. In a self light emitting display module shown in this FIG. 1, in addition to these, provided are a trouble detection means for detecting trouble in the self light emitting display unit and a memory means for storing detection results of this trouble detection means.

The strictures of the trouble detection means and the memory means will be described below with reference to the embodiment shown in FIG. 1. That is, respective inspection lines TL1-TLn are drawn from output terminals of the respective constant current sources I1-In in the anode line drive circuit 2 so that outputs of the current sources I1-In are supplied to a select switch SW1. This select switch SW1 functions to alternatively pick up output terminal potentials of the respective constant current sources I1-In obtained via the respective inspection lines TL1-TLn, and an electrical potential selected by the select switch SW1 is supplied to respective comparators CP1, CP2 provided as first and second voltage comparison means.

That is, the electrical potential selected by the select switch SW1 is supplied to the noninverting input terminal of the first comparator CP1 as well as to the inverting input terminal of the second comparator CP2 respectively. The reverse bias potential VM (second power source) is supplied to the inverting input terminal of the first comparator CP1. A logic operation potential VDD is supplied to the noninverting input terminal of the second comparator CP2.

Here, electrical potentials of respective portions in the structure shown in FIG. 1 and potential characteristics of the EL element are exemplified: the drive potential for driving the constant current sources I1-In (first power source) VH=16V; the reverse bias voltage (second power source) VM=10V; the forward voltage of the EL element VF=8V; the light emission threshold voltage of the EL element Vth=7V; the logic operation voltage VDD=3V; and the ground potential (third power source) VDD=0V. Since there are some variations in the forward voltages of the EL elements depending on respective light emission colors or even in the same light emission color elements, and thus the forward voltage of an EL element in a normal state may be expressed below also as an aimed VF value (=8V).

By the above-described potential relationship, the aimed VF value selected by the select switch SW1 is VF=8V, and this electrical potential is supplied to the noninverting input terminal of the first comparator CP1 and the inverting input terminal of the second comparator CP2. VM=10V is supplied to the inverting input terminal of the first comparator CP1, and therefore “−” (minus) is generated at the output of the first comparator CP1 when the light emitting display panel 1, the anode line drive circuit 2, and the cathode line scan circuit 3 are operating normally. VDD=3V is supplied to the noninverting input terminal of the second comparator CP2, and therefore “−” (minus) is similarly generated at the output of the second comparator CP2 when the light emitting display panel 1, the anode line drive circuit 2, and the cathode line scan circuit 3 are operating normally.

The outputs of the first and second comparators CP1, CP2 are supplied to a first latch circuit LC1 and a second latch circuit LC2, respectively, so that outputs of the respective comparators CP1, CP2 are latched by a latch pulse LP supplied to these first and second latch circuits LC1, LC2. Respective latch outputs A and B by the respective first and second latch circuits LC1, LC2 are supplied to a data register 6 constituting the memory means to be stored in this data register 6.

The self light emitting display module of the above-described structure is constructed so as to be switched between a light emission drive mode and a detection mode, and is switched to the detection mode for example at the time when operation power source is turned on or in a state in which the operation power source is turned on periodically or at an arbitrary time by an outside operation. When it is switched to the detection mode, for example at a predetermined timing during the period of one frame (or one subframe), all EL elements corresponding to one scan line are controlled to be lit. In the state shown in FIG. 1, the second scan line K2 is brought to the scan state, and currents from the respective constant current sources I1-In are supplied to the respective EL elements E12, E22, E32-En2 corresponding to this second scan line via the respective drive switches Sa1-San.

In this state, the select switch SW1 operates to supply the output terminal potentials of the respective constant current sources I1-In obtained via the respective inspection lines TL1-TLn one by one to the respective first and second comparators CP1, CP2. In this case, the select switch SW1 is connected to the inspection line TL1 first, and latch pulses LP are supplied to the respective first and second latch circuits LC1, LC2, so that the outputs A, B of the first and second comparators CP1, CP2 can be supplied to the data register 6. The data register 6 stores the outputs A, B of this time.

Subsequently, the select switch SW1 is connected to the inspection line TL2 so as to allow the data register 6 to store the outputs A, B of the first and second comparators CP1, CP2. In this manner, electrical potentials obtained via all inspection lines TL1-TLn corresponding to the respective constant current sources I1-In are inspected similarly, and the outputs A, B are stored in the data register 6.

The description above shows operations of the case where the second scan line K2 is brought to the scan state in the detection mode, and for example in the detection mode during the next one frame (or subframe) period, for example the next third scan line K3 is brought to the scan state to similarly inspect the electrical potentials obtained via all inspection lines TL1-TLn so as to allow the data register 6 to store the outputs A, B. Further, this is similarly performed also in the next one frame (or one subframe), so that all scan lines are brought to the scan state to allow the data register 6 to store the respective outputs A, B in respective situations.

That is, the above-described inspection (detection operation) is executed in all combinations between the respective scan lines and data lines corresponding to the respective EL elements E11-Enm in the light emitting display panel 1 respectively so that detection results based on the detection operation, that is, combinations of the outputs A, B are stored in the data register 6 provided as the memory means. Thus, a series of inspections for the self light emitting display unit including the light emitting display panel 1 and the anode line drive circuit 2 and the cathode line scan circuit 3 as the drive means are completed. The series of inspections are periodically executed repeatedly, and can be executed also at an arbitrary time by an outside operation.

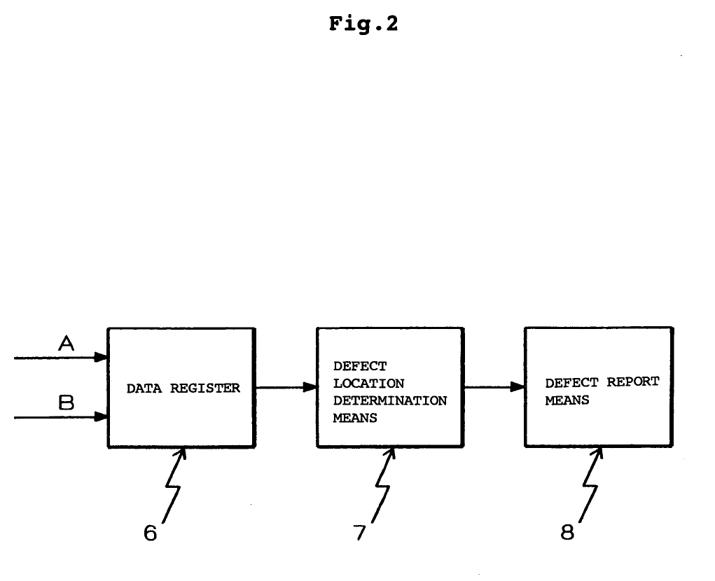

FIG. 2 shows a structure by which a location where trouble (defect) exists can be identified utilizing the respective inspection results stored in the data register 6 as described above, that is, combination data of the outputs A, B so that defect report mean scan be worked in accordance with this location. That is, reference numeral 6 shown in FIG. 2 represents the data register shown in FIG. 1, and the data constituted by combinations of the outputs A, B stored in this data register 6 is utilized in the defect location determination means designated by reference numeral 7 so as to determine (identify) a defect location in the self light emitting display unit including the light emitting display panel 1 and the anode line drive circuit 2 and the cathode line scan circuit 3 as the drive means. A defect report means 8 is driven in response to a defect location determined in the defect location determination means 7.

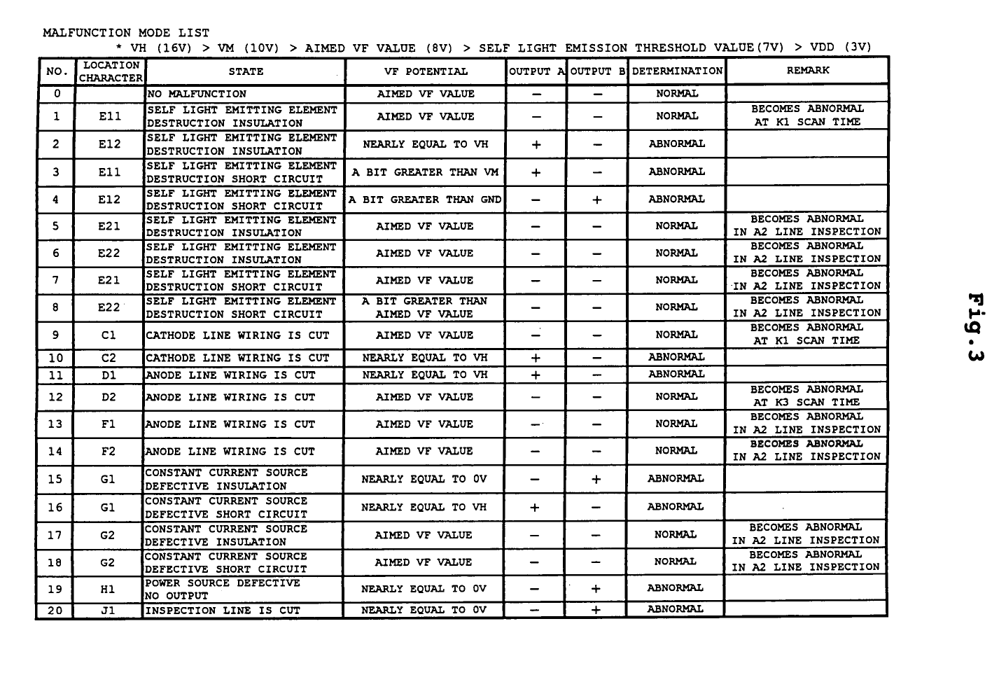

FIG. 3 explains a determination method performed in the defect location determination means shown in FIG. 2. The determination method shown in this FIG. 3 exemplifies a case where the second scan line K2 is connected to the ground to be in the scan state as shown in FIG. 1, where the reverse bias voltage VM is applied to the other scan lines K1, K3-Km, and where the select switch SW1 selects the inspection line TL1. The outputs A, B shown in FIG. 3 show respective output states of the first and second comparators CP1, CP2 stored in the data register 6 which is provided as the memory means already explained.

In FIG. 3, among those shown as location characters, for example, E11, E12, and the like denote EL elements shown in FIG. 1. Those shown by C1, C2 denote first and second cathode wiring portions designated by X marks in FIG. 1, and those shown in the below rows similarly denote location characters which are indicated together with X marks in FIG. 1. That is, by utilizing the determination method shown in FIG. 3, it can be determined that a portion designated by X mark together with a location character is defective as exemplified below.

As shown for example as No. 0 in FIG. 3, normal is determined when the outputs A and B are “−” and “−”, and “there is no malfunction” is determined as shown in the column regarding state when there is no abnormality in the outputs A, B even at the times of scanning the scan lines K1, K3 which are before and after the second scan line K2. Meanwhile, as shown as No. 1, in the case where abnormality occurs at the time of scanning the scan line K1 as shown in the column regarding remark though normal is determined while the outputs A and B are “−” and “−”, “the EL element E11 is broken so that the element is in a insulated state” is determined as shown in the columns regarding location character and state.

Further, as shown as No. 3, in the case where the outputs A and B are combination of “+” and “−” and abnormality is determined, “the EL element E12 is broken so that the element is in a insulated state” is determined as shown in the columns of location character and state. As shown for example as No. 9, in the case where abnormality occurs at the time of scanning the scan line K1 as shown in the remark column though the outputs A and B are “−” and “−” so that normal is determined, “the cathode line wiring is cut at the portion of C1” is determined as shown in the columns of location character and state.

Although the above-described explanation is part of the entire determination method shown in FIG. 3, combinations of location characters and states shown as No. 0 through No. 20 shown in FIG. 3 can be determined based on the data of the outputs A, B according to scan results of at least three adjacent scan lines. Similarly, treating other scan lines as objects, similar detections and determination operations based thereon are performed.

As described above, with the combination of the trouble detection means shown in FIG. 1 and the defect location determination means shown in FIG. 2, troubled light emission in all pixels by EL elements formed in a display panel can be detected, and the location of a troubled EL element (coordinate value) can also be detected. Besides EL elements, as designated by the location characters together with X marks in FIG. 1, trouble in the drive means of the display panel and these respective connecting portions can be determined individually.

The defect report means 8 is driven in response to a defect location determined in the defect location determination means 7. However, in this case, even when it is determined that defect has occurred for example in a pixel, if the defect location thereof is a position at which possibility of mistakenly recognizing display is low, an operation may be performed wherein the defect report means 8 is not operated so that the display panel is used as it is. For example, in the case where a defect location in pixels is of a position at which a decimal point is displayed, even if the number of pixels of defect is small, necessity of operating the defect report means 8 arises. It is desired that such a selection is appropriately set in accordance with equipment in which the present self light emitting display module is loaded.

As the defect report means 8, a means such as for example a buzzer which reports abnormality auditorily may be adopted, or a message reporting that a malfunction has occurred in the display panel 1 may be displayed. Alternatively, display of the display panel 1 may be extinguished so that it becomes apparent that there is a malfunction. In this case, if extinguishing display is not allowable such as for example in a case of a meter or the like which is used in an airplane, it may be considered that a means for appropriately changing display position is adopted.

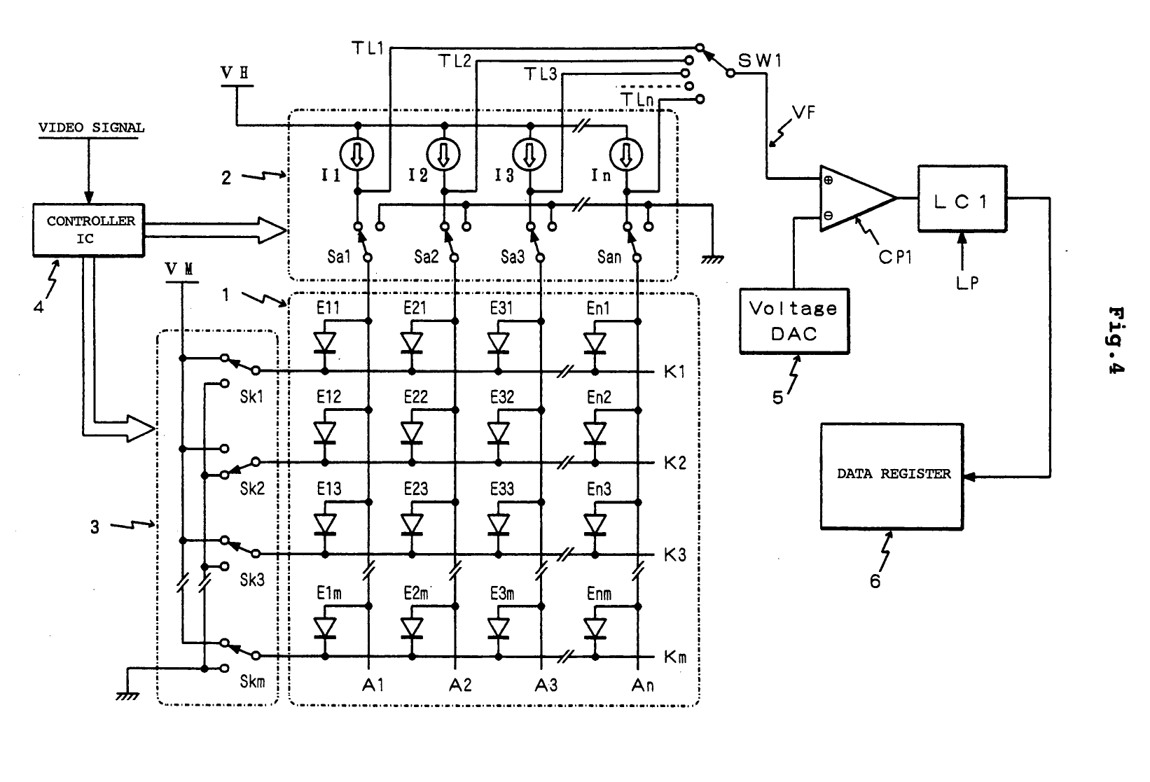

FIG. 4 shows a second embodiment of a self light emitting display module according to the present invention, and this also shows an example employing a passive matrix type display panel similarly. In this FIG. 4, parts corresponding to respective parts shown in FIG. 1 are designated by the same reference characters, and therefore detailed description thereof will be omitted.

In the embodiment shown in this FIG. 4, the output terminal potentials of the respective constant current sources I1-In selected by the select switch SW1 are supplied to the noninverting input terminal in one comparator CP1 constituting the voltage comparison means. A reference potential generation means 5 constructed such that the voltage value thereof is changeable is connected to the inverting input terminal of this comparator CP1. This reference potential generation means 5 functions to output an analog voltage whose value corresponds to inputted digital data by the inputted digital data.

In the embodiment shown in this FIG. 4, programming has been conducted such that the reference potential generation means 5 alternately outputs the reverse bias potential VM and the logic operation potential VDD which are respectively inputted to the first and second comparators CP1, CP2 shown in FIG. 1 as the reference potentials. Thus, the output terminal potential VF by one constant current source selected by the select switch SW1 is first compared with the electrical potential corresponding to the reverse bias potential VM supplied from the reference potential generation means 5, and its comparison output is supplied to the latch circuit LC1. When the latch pulse LP arrives, the comparison output is latched. The latch output by the latch circuit LC1 is stored in the data register 6 which constitutes the memory means.

Thereafter, the output terminal potential VF by the one constant current source is compared to the electrical potential corresponding to the logic operation potential VDD supplied next from the reference potential generation means 5, and its comparison output is supplied to the latch circuit LC1. Similarly, when the latch pulse LP arrives, the comparison output is latched. The latch output by the latch circuit LC1 is stored in the data register 6 constituting the memory means.

By the above-described operation, the comparison output (that is, this corresponds to the output A shown in FIG. 1) obtained by treating the reverse bias potential VM as a reference potential and the comparison output (that is, this corresponds to the output B shown in FIG. 1) obtained by treating the logic operation potential VDD as a reference potential are outputted from the latch circuit LC1 almost simultaneously, and this is stored in the data register 6. Therefore, by utilizing outputs corresponding to the outputs A, B stored almost simultaneously in the data register 6 shown in FIG. 4, a determination method similar to the example described with reference to FIG. 3 is utilized so that an occurrence state of trouble in the self light emitting display unit can be grasped.

Meanwhile, by constructing the comparator CP1 shown in FIG. 4 in such a manner that a constant reference potential is constantly supplied from the reference potential generation means 5, a simple type inspection means for a defect state can also be structured. In this case, for example about 6 volts of reference potential which is a bit lower than the above-mentioned aimed VF value (=8 volts) is supplied from the reference potential generation means 5 to the comparator CP1.

With this structure, in the case where the electrical potential VF selected by the select switch SW1 reaches the aimed VF value (=8 volts), the output of the comparator CP1 becomes “++”, and this state can be deemed roughly to be normal. Meanwhile, in the case where the output of the comparator CP1 becomes “−”, an EL element which is connected to a constant current source selected by the select switch SW1 and which is brought to the scan state can be deemed to be short circuited and poor quality.

Therefore, in the case where only the above-mentioned trouble of the EL elements arranged in the display panel is to be inspected, the above-described structure in which a constant reference potential is constantly supplied to one comparator CP1 can also be appropriately adopted.

In the embodiment shown in FIG. 4 also, similarly to the embodiment shown in FIG. 1, switching between the light emission drive mode and the detection mode is possible, and an occurrence state of trouble in the display unit as described above is detected in the state of the detection mode. However, in the embodiments shown in FIGS. 1 and 4, it is also possible to construct the module in such a manner that the detection operation for trouble by the trouble detection means is executed while the drive means are in the light emission drive operation, without shifting to the detection mode.

That is, the controller IC 4 shown in FIGS. 1 and 4 can grasp in advance a state of lighting control of the respective EL elements arranged in the display panel 1 when an input video signal is processed. Accordingly, for targeted EL elements which are driven to be lit, by specifying select operation of the select switch SW1, output timing of the latch pulse, and a write address for writing data in the data register 6, inspection data (the outputs A, B) can be obtained in conjunction with lighting timing of the respective EL elements. Further, the present module can be constructed such that the data for the data register 6 is accumulated and that the defect location determination means 7 shown in FIG. 2 is operated in the state in which determination by the determination method for example shown in FIG. 3 becomes possible.

In the embodiments described above, although organic EL elements are employed as self light emitting elements, these are not limited to the organic EL elements, and other self light emitting elements which are driven by current can be employed. Further, not only when the self light emitting display module including the trouble detection means is adopted in electronic equipment including a meter for medical equipment or airplanes already described, but also when it is adopted in other electronic equipment provided with a light emitting display panel, operations and effects already described can be produced as they are.

1. A self light emitting display module comprising
a self light emitting display unit composed of a light emitting display panel in which a large number of pixels including self light emitting elements are arranged at intersection positions between scan lines and data lines in a matrix pattern and a drive means for selectively driving and lighting the respective self light emitting elements in the light emitting display panel,
a trouble detection means for detecting trouble in the self light emitting display unit, and
a memory means for storing detection results which are obtained by the trouble detection means,
wherein the trouble detection means is constructed in such a way that an output terminal potential of a constant current source which supplies a constant current to the self light emitting elements is compared with a preset reference potential so as to detect trouble in the self light emitting display unit.

2. The self light emitting display module according to claim 1, wherein the drive means comprises a first power source, a second power source whose electrical potential is lower than that of the first power source, and a third power source whose electrical potential is further lower than that of the second power source,
wherein the first power source functions as an operational power supply of a constant power source supplying a lighting drive current to the respective self light emitting elements via the data lines, and the second and third power sources are supplied to the scan line via switching means so that the electrical potential of this scan line is selectively changed.

3. The self light emitting display module according to claim 2, wherein the drive means is constructed switchably between a light emission drive mode and a detection mode, wherein the output terminal potential of the constant current source is set at the light emission threshold voltage of the self light emitting element or higher in the detection mode and is set at an electrical potential which does not exceed the electrical potential of the second power source during a constant current drive for the self light emitting elements having no trouble.

4. The self light emitting display module according to claim 2, wherein while the drive means is still in a light emission drive operation, a detection operation for trouble by the trouble detection means is performed.

5. The self light emitting display module according to any one of claims 1 to 4, wherein the trouble detection means comprises one voltage comparison means, wherein any of the output terminal potentials of the constant current sources is selectively supplied to one side voltage input terminal of the voltage comparison means, and a reference potential is supplied to the other voltage input terminal of the voltage comparison means.

6. The self light emitting display module according to claim 5, wherein the voltage value of the reference potential supplied to the other voltage input terminal of the voltage comparison means is variable.

7. The self light emitting display module according to claim 1, wherein the trouble detection means comprises at least two voltage comparison means, wherein any of the output terminal potentials of the constant current sources is selectively supplied to one side voltage input terminals of the respective voltage comparison means, and respectively different reference potentials are supplied to the other voltage input terminals of the respective voltage comparison means.

8. The self light emitting display module according to claim 7, wherein one of the reference potentials respectively supplied to the other voltage input terminals of the respective voltage comparison means is equal to the electrical potential of the second power source, and the other of the reference potentials is set so as to be lower than the light emission threshold voltage of the self light emitting element and be higher than the electrical potential of the third power source.

9. The self light emitting display module according to any one of claim 7 or claim 8, wherein the trouble detection means comprises a select switch means for selecting the output terminal potentials of the constant current sources one after another to supply them to the respective voltage comparison means.

10. The self light emitting display module according to claim 1, wherein the detection operation by the trouble detection means is executed in all combinations between the respective data lines and the respective scan lines which correspond to the respective pixels in the light emitting display panel respectively, and detection results based on the detection operation are stored in the memory means.

11. The self light emitting display module according to claim 1, wherein the self light emitting elements arranged in the light emitting display panel are organic EL elements in which an organic compound is employed in a light emitting layer.

12. Electronic equipment into which the self light emitting display module according to claim 1 is loaded.

13. An inspection method of a defect state in a self light emitting display module which comprises
a self light emitting display unit composed of a light emitting display panel in which a large number of pixels including self light emitting elements are arranged at intersection positions between scan lines and data lines in a matrix pattern and a drive means for selectively driving and lighting the respective self light emitting elements in the light emitting display panel,
a trouble detection means for detecting trouble in the self light emitting display unit, and
a memory means for storing detection results which are obtained by the trouble detection means,
wherein a trouble detection step in which while a voltage comparison means provided in the trouble detection means is utilized, an output terminal potential of a constant current source which supplies a constant current to the self light emitting elements is compared with a preset reference potential so as to detect trouble in the self light emitting display unit and
a detection result storing step in which detection results detected in the trouble detection step are stored in the memory means
are executed in all combinations between the respective data lines and the respective scan lines which correspond to the respective pixels respectively.
